(19) United States
(12) Patent Application Publication
(10) Pub. No.: US 2024/0090514 A1
(43) Pub. Date: Mar. 21, 2024

(54) BIODEGRADABLE AND/OR EDIBLE TABLEWARE

(71) Applicant: TWIICE NEW ZEALAND LIMITED, Auckland (NZ)

(72) Inventors: Stephen Roland Cashmore, Auckland (NZ); James Gordon Cashmore, Auckland (NZ)

(21) Appl. No.: 18/284,832

(22) PCT Filed: Mar. 29, 2022
(86) PCT No.: PCT/IB2022/052914

§ 371 Date: Sep. 28, 2023

(30) Foreign Application Priority Data
Mar. 29, 2021 (AU) 2021900930

(51) Int. Cl. A21D 13/33; A21D 13/48

(52) U.S. Cl. CPC A21D 13/33; A21D 13/48

(57) ABSTRACT

Described is a method of forming a biodegradable and/or edible tableware that has a three dimensional shape in a two-step cooking process by first partially cooking a dough, that contains at least a flour and gelling agent, in a mould (subject to pressure and heat) and then baking the moulded tableware. The dough may include a sugar, and if present, is present at a ratio of the gelling agent to the sugar from 0.8:1 to 1:0.8. The dough may include a vegetable oil as the gelling agent and if the gelling agent is a vegetable oil, the dough includes the addition of water.

### FIELD OF THE INVENTION

The present invention relates to biodegradable and/or edible tableware, and a method of manufacture thereof.

### BACKGROUND TO THE INVENTION

The manufacture of edible tableware is known. However, such tableware may not be very robust and may lose its structural integrity when water (particularly hot water) is paled inside the item.

It is an object of the present invention to provide a biodegradable and/or edible tableware, to overcome any of the above-mentioned disadvantages, or to at least provide the public with a useful choice.

### SUMMARY OF THE INVENTION

Described is a method of forming a biodegradable and/or edible tableware that has a three dimensional shape in a two-step cooking process by first partially cooking a dough, that contains at least a flour and gelling agent, in a mould and then baking the moulded tableware.

Described is a method of forming a biodegradable and/or edible tableware that has a three dimensional shape in a two-step cooking process by first partially cooking a dough, that contains at least a flour and gelling agent, in a mould and then placing the dough into a mould and moulding the dough into the three dimensional shaped tableware at 150° C. to 220° C. and at least 800 kg of pressure.

Described is a method of forming a biodegradable and/or edible tableware that has a three dimensional shape in a two-step cooking process by first partially cooking a dough, that contains at least 45 to 65% by weight of a flour and a gelling agent, placing the dough into a mould and moulding the dough into the three dimensional shaped tableware at 150° C. to 220° C. and at least 800 kg of pressure.

There is further described a method for making biodegradable and/or edible tableware having a three dimensional shape, comprising
a) forming a dough, the dough comprising a mixture of
   45 to 65% by weight of a flour,
   35 to 55% by weight of a gelling agent and a sugar, the ratio of the gelling agent to the sugar being from 0.8:1 to 1:0.8,
b) placing the dough into a mould and subjecting the dough to both heat and pressure to form the three dimensional shaped tableware,
c) baking the three dimensional shaped tableware to form the biodegradable and/or edible tableware.

There is further described a method for making biodegradable and/or edible tableware having a three dimensional shape, comprising
a) forming a dough, the dough comprising a mixture of
   45 to 65% by weight of a flour,
   35 to 55% by weight of a gelling agent and a sugar, the ratio of the gelling agent to the sugar being from 0.8:1 to 1:0.8,
b) placing the dough into a mould and moulding the dough into the three dimensional shaped tableware at 150° C. to 220° C.,
c) baking the three dimensional shaped tableware to form the biodegradable and/or edible tableware.

There is further described a method for making biodegradable and/or edible tableware having a three dimensional shape, comprising
a) forming a dough, the dough comprising a mixture of
   45 to 65% by weight of a flour,
   35 to 55% by weight of a gelling agent and a sugar, the ratio of the gelling agent to the sugar being from 0.8:1 to 1:0.8,
b) placing the dough into a mould and subjecting the dough to both heat and pressure to form the three dimensional shaped tableware,
c) baking the three dimensional shaped tableware to form the biodegradable and/or edible tableware having
   i) a wall thickness of 3 to 5 mm, or
   ii) a density of 0.45 to 0.65 relative to water, or
   iii) a water activity (a_{w}) of less than 0.54, or
   iv) a moisture content of less than 6.5 g/100 g, or
   v) a protein content of 8 to 16 g/100 g, or
   vi) the capability of retaining a liquid without leaking the liquid for at least 2, 4, 8, 12 hrs, or 1, 2, 3, 4, 5, 6 or 7 days, or
   vii) any combination of (i) to (vi).

There is further described a method for making biodegradable and/or edible tableware having a three dimensional shape, comprising
a) forming a dough, the dough comprising a mixture of
   45 to 65% by weight of a flour,
   35 to 55% by weight of a gelling agent and a sugar, the ratio of the gelling agent to the sugar being from 0.8:1 to 1:0.8,
b) placing the dough into a mould and moulding the dough into the three dimensional shaped tableware at 150° C. to 220° C. and at least 800 kg of pressure,
c) baking the three dimensional shaped tableware to form the biodegradable and/or edible tableware having
   i) a wall thickness of 3 to 5 mm, or
   ii) a density of 0.45 to 0.65 relative to water, or
   iii) a water activity (a_{w}) of less than 0.54, or
   iv) a moisture content of less than 6.5 g/100 g, or
   v) a protein content of 8 to 16 g/100 g, or
   vi) the capability of retaining a liquid without leaking the liquid for at least 1, 2, 3, 4, 5, 6 or 7 days, or
   vii) any combination of (i) to (vi).

There is further described biodegradable and/or edible tableware formed from flour, a gelling agent and sugar and having
a wall thickness of 3 to 5 mm, or
a density of 0.45 to 0.65 relative to water, or
a water activity (a_{w}) of less than 0.54,
a moisture content of less than 6.5 g/100 g,
a protein content of 8 to 16 g/100 g, and
the capability of retaining a liquid without leaking the liquid for at least 1, 2, 3, 4, 5, 6 or 7 days.

There is further described biodegradable and/or edible tableware formed from 45 to 65% by weight of a flour, 35 to 55% by weight of a gelling agent and sugar, the ratio of the gelling agent to the sugar being from 0.8:1 to 1:0.8 and having
i) a wall thickness of 3 to 5 mm, or
ii) a density of 0.45 to 0.65 relative to water, or
iii) a water activity (a_{w}) of less than 0.54, or
iv) a moisture content of less than 6.5 g/100 g, or
v) a protein content of 8 to 16 g/100 g, or
vi) the capability of retaining a liquid without leaking the liquid for at least 1, 2, 3, 4, 5, 6 or 7 days, or
vii) any combination of (i) to (vi).

Any one or more of the following embodiments may relate to any of the aspects described herein or any combination thereof.

In one configuration the gelling agent is a vegetable oil. The vegetable oil may be selected from rice bran oil, coconut oil, rape seed oil. When a vegetable oil is used, the dough includes the addition of water.

In one configuration when water is added it comprises 10, 15, 20, 25, or 30% by weight of the dough, and suitable ranges may be selected from between any of these values.

In one configuration the dough comprises 45, 50, 55, 60 or 65% by weight of a flour, and suitable ranges may be selected from between any of these values.

In one configuration the flour is selected from wheat flour, gluten free flour, coconut flour, white rice flour, brown rice flour, buckwheat flour, cornmeal, chick pea flour or a combination thereof.

In one configuration the flour is gluten free, and comprises at least gluten free flour and a further flour selected from coconut flour, white rice flour, brown rice flour, flour from seeds such as chia, flaxseeds, almond, hazelnut, or a combination thereof.

In one configuration the flour is gluten free and comprises psyllium husk.

In one configuration the flour is gluten free and comprises rice flour.

In one configuration the flour comprises a ratio of brown rice flour to coconut flour of about 1:1 to about 1.4:1, and suitable ranges may be selected from between any of these values.

In one configuration the flour comprises psyllium husk.

In one configuration the gelling agent is selected from egg, an egg substitute, cornstarch, aquafaba, or a combination thereof.

In one configuration the dough comprises about 15, 20, 25 or 30% by weight of the gelling agent, and suitable ranges may be selected from between any of these values.

In one configuration the egg is selected from whole egg or whole egg powder, or a combination thereof.

In one configuration the dough comprises about 15, 20, 25 or 30% by weight of the sugar, and suitable ranges may be selected from between any of these values.

In one configuration the sugar is selected from granulated sugar. A method of any one of claims 1 to 3 wherein the granulated sugar is sourced from sugar cane or sugar beets.

In one configuration the sugar is selected from coconut sugar.

In one configuration the sugar is selected from glucose syrup.

In one configuration the dough comprises 0.5, 1.0, 1.5, 2.0, 2.5, 3.0, 3.5, 4.0, 4.5, 5.0, 5.5, 6.0, 6.5, 7.0 or 7.5% by weight corn-starch, and suitable ranges may be selected from between any of these values.

In one configuration the dough includes an oil source.

In one configuration the oil source is selected from a vegetable oil, or a ground oil-containing seed.

In one configuration the vegetable oil is selected from high smoke point oils. A method of any one of claims 1 to 3 wherein the oil has a smoke point greater than 220° C.

In one configuration the vegetable oil is selected from rice bran oil, refined avocado oil, refined safflower oil, Neutralized, dewaxed, bleached & deodorized sunflower oil, clarified butter, mustard oil, pecan oil, difractionated palm oil, soybean oil, refined peanut oil, semi refined sesame oil, semi refined sunflower oil, corn oil, peanut oil, sunflower oil, almond oil, canola oil or a combination thereof.

In one configuration the ground oil-containing seed is ground flax seed.

In one configuration the dough includes a flavouring agent.

In one configuration the dough comprises up to about 1, 2, 3, 4, 5, 6, 7, 8, 9 or 10% by weight of a flavouring agent, and suitable ranges may be selected from between any of these values.

In one configuration the biodegradable and/or edible tableware was a wall thickness of 3, 3.5, 4, 4.5 or 5 mm, and suitable ranges may be selected from between any of these values.

In one configuration the biodegradable and/or edible tableware has a density of 0.45, 0.50, 0.55, or 0.60 relative to water, and suitable ranges may be selected from between any of these values.

In one configuration the biodegradable and/or edible tableware has a water activity (a_{w}) of 0.30, 0.35, 0.40, 0.45, 0.50, 0.55, and suitable ranges may be selected from between any of these values.

In one configuration the biodegradable and/or edible tableware has a moisture content of less than 6.5 g/100 g.

In one configuration the biodegradable and/or edible tableware has a protein content of 8, 9, 10, 11, 12, 13, 14, 15 or 16 g/100 g, and suitable ranges may be selected from between any of these values.

In one configuration the moulding apparatus comprises a male ram whose exterior shape mirrors that of the desired internal shape of the biodegradable and/or edible tableware.

In one configuration the moulding apparatus comprises a female mould whose inner surface mirrors that of the desired external shape of the biodegradable and/or edible tableware.

In one configuration the male ram is heated.

In one configuration the male ram is heated to 150, 160, 170, 180, 190, 200, 210 or 220° C., and suitable ranges may be selected from between any of these values.

In one configuration the mould can exert a force of at least one ton.

In one configuration the female mould includes a removable insert, into which the dough is placed for molding.

In one configuration the mould allows any generated steam to be released from the dough.

In one configuration the mould is an open mould.

In one configuration the mould is a closed mould configured to vent any generated steam.

In one configuration the gelling agent and sugar are mixed to form a first mixture.

In one configuration the sugar is substantially dissolved in the first mixture.

In one configuration the flavouring agent is added to the first mixture.

In one configuration the flour is added to the first mixture.

In one configuration the dough moulding temperature (prior to placing into the mould) is 12, 13, 14, 15, 16, 17, 18, 19, 20, 21, 22 or 23° C., and suitable ranges may be selected from between any of these values.

In one configuration the dough is placed into the female mould in no particular pre-formed shape.

In one configuration the dough is cooked in the mould for about 1, 2, 3, 4, 5, 6, 7, 8, 9, 10, 15, 20, 25 or 30 sec, and suitable ranges may be selected from between any of these values.

In one configuration the partially cooked biodegradable and/or edible tableware is removed from the mould and baked at 150, 160, 170, 180, 190, 200, 210 or 220° C., and suitable ranges may be selected from between any of these values.

In one configuration the partially cooked biodegradable and/or edible tableware is baked for 7, 8, 9, 10, 11, 12, 13, 14, or 15 min, and suitable ranges may be selected from between any of these values.

In one configuration the biodegradable and/or edible tableware is in the form of a cup, mug, plate, bowl or cutlery.

In one configuration the biodegradable and/or edible tableware is able to withstand immersion in water for at least 1, 2, 3, 4, 5, 6 or 7 days without losing its structural integrity.

In one configuration the biodegradable and/or edible tableware in the form of a cup or mug is able to contain water without leaking for at least 1, 2, 3, 4, 5, 6 or 7 days.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 is a cross sectional view of an outer mould (male ram).

FIG. 2 is a cross sectional view of an inner mould (female mould).

FIG. 3A shows the three different sections of the cup that where separately analysed.

FIG. 3B shows the parts of the cross section of the cup that were analysed.

FIG. 3C shows the orientation of the cross sectional analysis.

FIG. 4 shows photos of cups as described.

FIG. 5A to 5C show scanning electron microscopy at low (50× magnification)(FIG. 5A), mid (200× magnification)(FIG. 5B) and high (500× magnification)(FIG. 5C) of the surface of the inside of the Cupffee™ Cup.

FIGS. 6A to 6C shows scanning electron microscopy at low (50× magnification)(FIG. 6A), mid (200× magnification)(FIG. 6B) and high (500× magnification)(FIG. 6C) of the outside of the inside of the Cupffee™ Cup.

FIGS. 7A to 7C shows scanning electron microscopy at low (50× magnification)(FIG. 7A), mid (200× magnification)(FIG. 7B) and high (500× magnification)(FIG. 7C) of the cross-section of the Cupffee™ cup.

FIG. 8 shows the cross-section of the Cupffee™ cup across the top mid and base sections of the cups.

FIGS. 9A to 9C shows scanning electron microscopy at low (50× magnification)(FIG. 9A), mid (200× magnification)(FIG. 9B) and high (500× magnification)(FIG. 9C) of the inside surface of the Cupffee™ cup.

FIGS. 10A to 10C shows scanning electron microscopy at low (50× magnification)(FIG. 10A), mid (200× magnification)(FIG. 10B) and high (500× magnification)(FIG. 10C) of the surface of the base of the Cupffee™ cup.

FIGS. 11A to 11C shows scanning electron microscopy at low (50× magnification)(FIG. 11A), mid (200× magnification)(FIG. 11B) and high (500× magnification)(FIG. 11C) of the inside surface of the base of the Twiice® cups.

FIGS. 12A to 12C shows scanning electron microscopy at low (50× magnification)(FIG. 12A), mid (200× magnification)(FIG. 12B) and high (500× magnification)(FIG. 12C) of the outside surface of the base of the Twiice® cups.

FIGS. 13A to 13C shows scanning electron microscopy at low (50× magnification)(FIG. 13A), mid (200× magnification)(FIG. 13B) and high (500× magnification)(FIG. 13C) of the cross section of the Twiice® cups.

### DETAILED DESCRIPTION OF THE INVENTION

Described is a method of forming a biodegradable and/or edible tableware that has a three dimensional shape in a two-step cooking process by first partially cooking a dough, that contains at least a flour, a gelling agent and sugar, in a mould and then baking the moulded tableware. The dough comprises a mixture of 45 to 65% by weight of a flour, 35 to 55% by weight of a gelling agent and a sugar. The ratio of the gelling agent to the sugar being from 0.8:1 to 1:0.8.

The dough is placed into a mould which subjects the dough to both heat and pressure to form the three dimensional shaped tableware.

Still in the mould the partially cooked tableware is transferred to an oven for baking which reduces the moisture content. The present cups can be made from basic ingredients without the use of additives or processing aids.

The biodegradable and/or edible tableware is made from flour and a gelling agent. The dough may also include a sugar.

The dough comprises about 45, 50, 55, 60 or 65% by weight of a flour, and suitable ranges may be selected from between any of these values, (for example, about 45 to about 65, about 45 to about 60, about 45 to about 50, about 50 to about 65, about 50 to about 55, about 55 to about 65 or about 55 to about 60% by weight). The flour can be selected from a range of different flours such as wheat flour, gluten free flour, coconut flour, white rice flour, brown rice flour, buckwheat flour, cornmeal, chick pea flour or a combination thereof.

There are many commercially available wheat flours. For example, the present inventors have used Champion Medal® flour, but it will be appreciated that any commercially available flour can be used. Expressed as grams per 100 g of flour, standard wheat flour typically contains about 10 g of protein, <2 g of, about 70 g of carbohydrate and about 3.5 g-4 g of fibre. The flour may assist in providing the structure in the baked good—for example, wheat flour contains proteins that interact with each other when mixed with water to form gluten. The elastic gluten forms a framework.

The protein content of a flour affects the strength of a dough. In some embodiments the flour for use to make the dough as described has a protein content of about 9, 9.5, 10, 10.5, or 11% by weight of the flour, and suitable ranges may be selected from between any of these values, (for example, about 9 to about 11, about 9 to about 10.5, about 9 to about 10, about 9.5 to about 11, about 9.5 to about 10.5 or about 9.5 to about 10% by weight).

In some embodiments it may be possible to use a low protein flour such as the Champion® Halo flour. In some embodiments the Halo flour provides longer developing time for the dough. For example the mixture containing the Halo flour may stand for up to 45 min. The Halo flour is a white low protein soft flour. In such cases it may be necessary to add corn-starch that will assist in providing a product with the suitable strength and hardness. For example, as little as 0.5, 1.0, 1.5 or 2% corn-starch can assist the use of lower protein flours to produce a suitable product. The corn-starch can also be used with “standard” flours as well, and it will be appreciated that the final product will have a higher degree of hardness. For example, amounts of corn-starch as high as 4, 4.5, 5, 5.5, 6, 6.5, 7 or 7.5% by weight could be used to obtain a harder product.

The present disclosure can also be provided with gluten free flour, which is important to produce cups for people with dietary restrictions on gluten (e.g. celiacs). The gluten-free flour alternatives generally attempt to mimic the functionality and texture of wheat flour. The gluten-free flours may contain or include rice, corn, potato, tapioca, arrowroot, buckwheat, amaranth, bean, quinoa, sorghum, flax meal or ground nuts, typically as a blend. For example, in some embodiments that seek to reduce or remove gluten the flour is provided for by a commercially available gluten free flour such as Bakels gluten free flour. The Bakels range of flour provides bread mix flour, baking mix flour, artisan bread mix and flour: for the purpose of making a dough as described the flour product was used. It should be appreciated that the difference between the flours is typically the amount of protein present.

In some embodiments the gluten free flour comprises a gluten free flour (such as Bakels gluten free flour) in combination with another flour, such as coconut flour, white rice flour, brown rice flour or a combination thereof. We have found coconut flour to be particularly effective. Coconut flour is a soft, naturally grain- and gluten-free flour produced from dried coconut meat. It contains about 20% protein, 13% fat, 60% carbohydrate and about 33% fibre. The gluten free flour may use about 5, 10, 15, or 20% of one of the aforementioned flours.

In some embodiments the gluten free flour may be combined with psyllium husk, a source of soluble fibre.

In some embodiments the flour may be provided by a mixture of rice flour, such as white and brown rice flour. The blend of rice powder may be used in a ratio of about 1:0.8 to 0.8:1 of white to brown rice flour. In one embodiment the flour comprises a ratio of brown rice flour to coconut flour of about 1:1 to about 1.4:1. White rice flour contains 7-10% protein, 75-82% carbohydrates, and 0.7-1% fat. Brown rice flour contains about 7.2% protein, 76% carbohydrates, and 2.8% fat.

Gelling agents are useful in baking as they assist in binding together and stabilising the ingredients. The dough may contain a bout 15, 20, 25 or 30% by weight of the gelling agent, and suitable ranges may be selected from between any of these values, (for example, about 15 to about 30, about 15 to about 25, about 15 to about 20, about 20 to about 30 or about 20 to about 25% by weight).

Egg is a gelling agent used in baking and adds structure, leavening, colour, and flavour. The egg may be selected from whole egg or whole egg powder, or a combination thereof. If a whole egg powder is used, then this is typically first mixed with water. For example, a whole egg powder may be mixed to provide 30% total solids hence mixed with 70% water by weight.

Eggs contain both protein that interacts with starches present in other ingredients (e.g. the flour) to enhance the structure of the baked product. The heat applied helps to coagulate the protein present.

A non-egg gelling agent may also be used, such as an egg substitute (e.g. dairy based egg substitutes that contain dairy protein and dairy fat), cornstarch as described above, or aquafaba. Aquafaba assists in making a vegan product. Aquafaba contains starch which acts as a binder.

A further gelling agent is a vegetable oil. When a vegetable oil is used, then water is also added to form the dough. The vegetable oil may be selected from The vegetable oil may be selected from rice bran oil, coconut oil, rape seed oil. When water is added it forms 10, 15, 20, 25 or 30% of the dough by weight.

Sugar is made up of sucrose which is available from sugar cane and sugar beets. Sugar also helps to leaven baked goods and can provide a structure for gas expansion in the oven. Granulated sugar is a refined sugar that is white in colour and is the most common type of sugar used in baking. Granulated sugar has a slight coarseness to it but is still a very fine grain.

Various other sources of sugar can be used as well. For example, the sugar may be selected from coconut sugar. Alternately, the sugar may be selected from glucose syrup. If glucose syrup is used, then it may require the addition of water (e.g. around 33% water to the amount of glucose syrup).

In some embodiments the dough comprises about 15, 20, 25 or 30% by weight of the sugar, and suitable ranges may be selected from between any of these values, (for example, about 15 to about 30, about 15 to about 25, about 15 to about 20, about 20 to about 30 or about 20 to about 25% by weight).

The dough may also include the addition of corn-starch. The dough may comprise 0.5, 1.0, 1.5, 2.0, 2.5, 3.0, 3.5, 4.0, 4.5, 5.0, 5.5, 6.0, 6.5, 7.0 or 7.5% by weight corn-starch, and suitable ranges may be selected from between any of these values.

The dough may also include the addition of an oil source. The oil may act to coat the flour. The oil may be added to stop the flour proving. The oil source is selected from a vegetable oil, or a ground oil-containing seed.

In some embodiments the vegetable oil is selected from high smoke point oils, for example that have a smoke point greater than about 220° C. Thus the oil may be selected from rice bran oil, refined avocado oil, refined safflower oil, Neutralized, dewaxed, bleached & deodorized sunflower oil, clarified butter, mustard oil, pecan oil, difractionated palm oil, soybean oil, refined peanut oil, semi refined sesame oil, semi refined sunflower oil, corn oil, peanut oil, sunflower oil, almond oil, canola oil or a combination thereof.

Many seeds also contain oil. In some embodiments the oil is sourced from an oil-containing seed such as ground flax seed.

The dough may also contain a flavouring agent. The dough may comprise up to about 1, 2, 3, 4, 5, 6, 7, 8, 9 or 10% by weight of a flavouring agent, and suitable ranges may be selected from between any of these values (for example, about 1 to about 10, about 1 to about 9, about 1 to about 7, about 1 to about 6, about 1 to about 5, about 2 to about 10, about 2 to about 8, about 2 to about 6, about 3 to about 10, about 3 to about 7, about 3 to about 5, about 4 to about 10, about 4 to about 8, about 5 to about 10, about 5 to about 9 or about 6 to about 10% by weight).

The flavouring agent may include any natural or artificial flavouring as used in baking. For example, see the Sensient Technologies range of flavourings, and particularly the vanilla flavouring.

When forming the dough the gelling agent and sugar may first be mixed to form a first mixture. The sugar is substantially dissolved in the first mixture. Substantially, means at least 80, 85, 90, 95 or 99% of the sugar is dissolved. When a flavouring agent is added it is preferably added to the first mixture. The mixer can be any food mixer.

The flour may then be added to the first mixture after the gelling agent and sugar are mixed, and the sugar substantially dissolved.

The dough is placed into the mould. The dough moulding temperature (prior to placing into the mould) is may be 12, 13, 14, 15, 16, 17, 18, 19, 20, 21, 22 or 23° C., and suitable ranges may be selected from between any of these values.

A benefit may include that the dough can be placed into the female mould in no particular pre-formed shape. That is, it does not have to be formed into a particular shape, nor placed into a particular location in the mould.

The dough may be cooked in the mould for about 1, 2, 3, 4, 5, 6, 7, 8, 9, 10, 15, 20, 25 or 30 sec, and suitable ranges may be selected from between any of these values.

In some embodiments an internal insert is placed inside the partially cooked biodegradable and/or edible tableware, the insert having a shape that corresponds to the internal surface of the biodegradable and/or edible tableware.

The partially cooked biodegradable and/or edible tableware is removed from the mould (optionally with an internal inset placed inside the biodegradable and/or edible tableware) and may be baked at 150, 160, 170, 180, 190, 200, 210, or 220° C., and suitable ranges may be selected from between any of these values. For example, the partially cooked tableware may be cooked in an oven. The partially cooked tableware may be placed into the middle of the oven.

The partially cooked biodegradable and/or edible tableware may be baked for 7, 8, 9, 10, 11, 12, 13, 14, or 15 min, and suitable ranges may be selected from between any of these values.

As described above, the dough is moulded to form the biodegradable and/or edible tableware. The present invention describes apparatus 100 to manufacture biodegradable tableware.

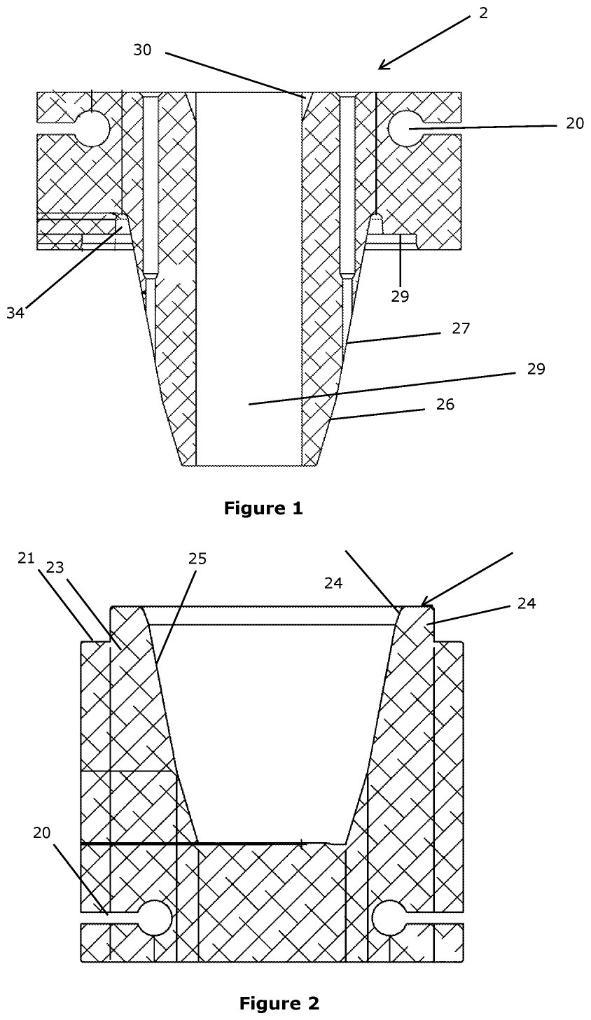

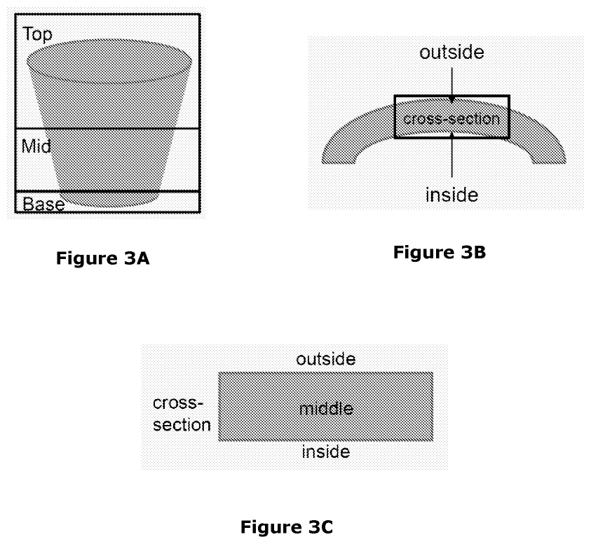

As shown in FIGS. 1 and 2 are the male and female components of a moulding apparatus for manufacturing tableware, in this case, for a cup. As shown in FIG. 1 is the male ram of the and by FIG. 2 the corresponding female part of the mould. Generally, the apparatus works by the inner (male) and outer (female) moulds being brought together following the injection of a dough between the moulds. The dough is then moulded into the desired shape as defined by the relative shape of the outer surface 26 of the inner mould 2, and the inner surface 25 of the outer mould 1.

The inner and outer moulds move between an engaged relationship and an unengaged relationship (where they are spaced from each other). Thus the inner and outer moulds require an actuating mechanism 19 to move between the engaged relationship and an unengaged relationship.

In one embodiment the actuation mechanism 19 may be a manual level press mechanism. In an alternate embodiment the actuation mechanism is selected from a pneumatic, hydraulic or electrically driven press. For example, a pneumatic actuation mechanism may comprise a piston within a cylinder, in which the piston 4 is actuated to extend from the cylinder through the injection of compressed air into the cylinder. An example of such a pneumatic actuation mechanism are pneumatic drives such as provided by FESTO.

Hydraulic drive systems are known, which uses pressurised fluid to power a piston. Alternately the actuation mechanism could be an electrical motor that drives the moulds together, such as by driving a piston or moving the moulds together, for example on a rack and pinion system.

The male ram has an exterior shape that mirrors that of the desired internal shape of the biodegradable and/or edible tableware. The female mould has an inner surface mirrors being shaped to the desired external shape of the biodegradable and/or edible tableware.

In one embodiment the inner mould, the outer mould, or both the inner and outer mould may include a heating mechanism 20. The heating mechanism 20 heats the moulded dough to at least partially harden the dough.

The mould components may be heated to 150, 160, 170, 180, 190, 200 210 or 220° C., and suitable ranges may be selected from between any of these values, (for example, about 150 to about 210, about 150 to about 200, about 150 to about 190, about 150 to about 180, about 160 to about 210, about 160 to about 200, about 160 to about 190, about 160 to about 180, about 170 to about 210, about 170 to about 200, about 170 to about 190, about 170 to about 180, about 180 to about 210 or about 180 to about 200° C.).

The ram may exert a force of at least about 700, 800, 900, 1000, 1100, 1200 kg when moulding the biodegradable and/or edible tableware, and suitable ranges may be selected from between any of these values.

The female mould, the male mould or both the female and male mould may include a non-stick coating. For example, the coating may be any such coating as used in commercial bread making to prevent sticking. The coating may be ‘perfluroalkoxy. This coating seems to have good robustness, maintenance of integrity and slippage.

The female mould may include a removable insert, into which the dough is placed for molding. The removable insert may be formed from aluminium, stainless steel, mild-steel, PTFE or teflon. When placed into the oven, the partially cooked tableware may be retained in a mould insert.

When used with an internal insert the partially cooked biodegradable and/or edible tableware is sandwiched between the removable insert and the internal insert, and this placed to be baked in this condition.

We have found that the heat setting of the male ram (when heated) influences the rise of the dough during the pressing process and the dough can rise within a few seconds. We have found a range of temperature from 150° C. to 190° C. works with 180° C. being optimum.

Without wishing to be bound by theory, the escape of steam may be an important mechanism to create the cup microstructure, and in particular the formation of the walls of the cup comprising pores. Thus the mould allows steam to escape during the moulding process. The mould may be a closed mould as shown in FIGS. 1 and 2 wherein the upper surface of the female mould 21 indexes to a lower surface 29 of the male mould. In such a configuration the mould may include one or more apertures to allow release of steam from the mould. Alternately the mould may be an open mould, that is, the upper surface of the cup as it rises in the mould is free to vent any steam into ambient.

The biodegradable and/or edible tableware may be in the form of a cup, mug, plate, bowl or cutlery.

The biodegradable and/or edible tableware may be able to withstand immersion in a liquid for at least 2, 4, 8, 12 hrs or 1, 2, 3, 4, 5, 6 or 7 days without losing its structural integrity. A test used to measure the structural integrity is to place boiling water in the tableware (providing it can hold the boiling water such as a cup or mug) and to then see how long it takes for the water to leak from the tableware product.

In some embodiments, where the biodegradable and/or edible tableware in the form of a cup or mug, it may be able to contain water without leaking for at least 2, 4, 8, 12 hrs or 1, 2, 3, 4, 5, 6 or 7.

Where the tableware is in the form of a container, such as a cup, mug, bowl, container etc, it may be able to retain thicker (viscosity) food items such as curry's, thick soup, ice creams, baked desserts, indefinitely without leaking the food item.

The biodegradable and/or edible tableware may have a wall thickness of 3, 3.5, 4, 4.5 or 5 mm, and suitable ranges may be selected from between any of these values, (for example, about 3 to about 5, about 3 to about 4.5, about 3 to about 4, about 3.5 to about 5, about 3.5 to about 4 or about 4 to about 5 mm).

The biodegradable and/or edible tableware may have a density of 0.45, 0.50, 0.55, or 0.60 relative to water, and suitable ranges may be selected from between any of these values, (for example, about 0.45 to about 0.60, about 0.45 to about 0.55, about 0.45 to about 0.50 or about 0.50 to about 0.60 relative to water).

The biodegradable and/or edible tableware may have a water activity (a_{w}) of 0.30, 0.35, 0.40, 0.45, 0.50, 0.55, and suitable ranges may be selected from between any of these values, (for example, about 0.30 to about 0.55, about 0.30 to about 0.50, about 0.30 to about 0.45, about 0.35 to about 0.60, about 0.35 to about 0.55, about 0.35 to about 0.50, about 0.35 to about 0.40, about 0.40 to about 0.55 or about 0.40 to about 0.50 a_{w}).

The biodegradable and/or edible tableware may have a moisture content of less than 6.5 g/100 g.

The biodegradable and/or edible tableware may have a protein content of 8, 9, 10, 11, 12, 13, 14, 15 or 16 g/100 g, and suitable ranges may be selected from between any of these values.

### 1. Examples

### 1.1 Analysis of the Surface Structure of the Cups

This example was conducted to compare the surface and cross sectional structure of the Test Cup (Twiice® Cup) and a competitor cup: the Cupffee™ cup.

Shown in Table 1 are the ingredients used to make the Twiice® cup which are the same as used in Formulation 3 of Table 3. The cups were formed by taking approximately 72-75 g of dough and placing into a mould (no specific shape required). The heated ram (180° C.) is brought into contact with the dough to form the cup shape in the female mould and held there for about 2-4 seconds. The formed cup is then baked in an oven at 180° C. for at least 10 min or until golden brown. Shown in Table 2 is the nutritional information for the Twiice® cup and the Cupffee™ cup. Note that the nutritional information for the Twiice® cup is the same as that for Formulation 3 of Table 5. The Cupffee™ cup is essentially a biscuit based cup absent any thermal or moisture or resistance coating. According to the Cupffee patent application their ingredients are: oat bran, flour, sugar, gluten, margarine, alginate, xanthan gum, salt and potassium sorbate.

TABLE 1
Ingredients for making the Twiice ® cup

| Ingredient | Amount (g) |
|---|---|
| ‘Champion’ Halo [mix] flour | 750 |
| Cornstarch | 10 |
| Water | 290 |
| Sugar | 310 |
| Vanilla flavour 63045 | 8 |
| Rice bran oil | 14 |

TABLE 2
Nutritional information for Twiice ® cup and Cupffee ™ cup

Average quantity per 100 g

| | | |
|---|---|---|
| Energy (kCal) | 402 | 383 |
| Protein (g) | 13 | 6.6 |
| Fat, total (g) | 4.2 | 2.4 |
| Saturated (g) | 2.8 | 0.4 |
| Carbohydrate (g) | 78 | 82.5 |
| sugars (g) | 13 | 30.5 |
| Sodium (mg) | 200 | 3 |

Imaging of the Test cup (Twiice® Cup) and Cupffee™ cups were via scanning electron microscopy (SEM) to examine the surface of the cups and the internal structure.

Density measurements were also carried out using a hydrostatic gravimetric method.

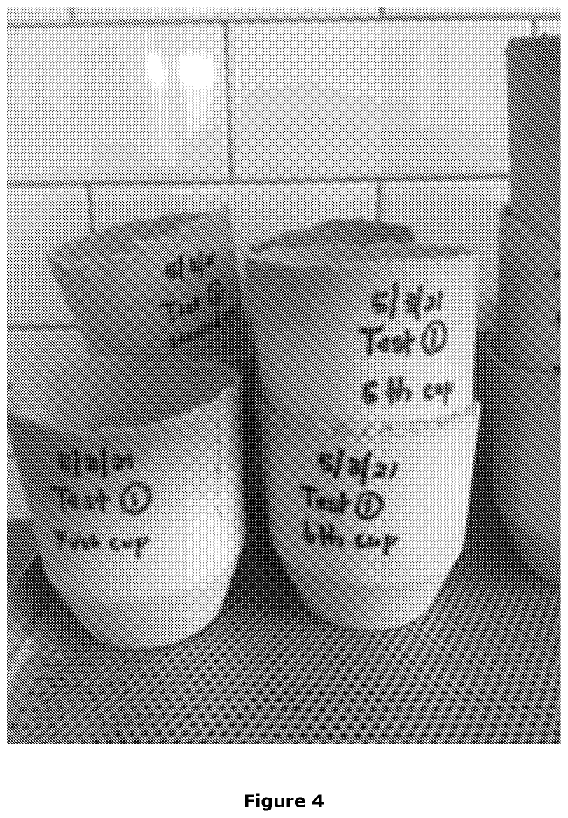

As shown in FIG. 3A three replicates were analysed. The cups were fractions into three components as shown in FIG. 3A: top, middle and base. The cross-section was also analysed between the outside, middle and inside as shown in FIG. 3C.

A total of 645 images of the two cups were obtained.

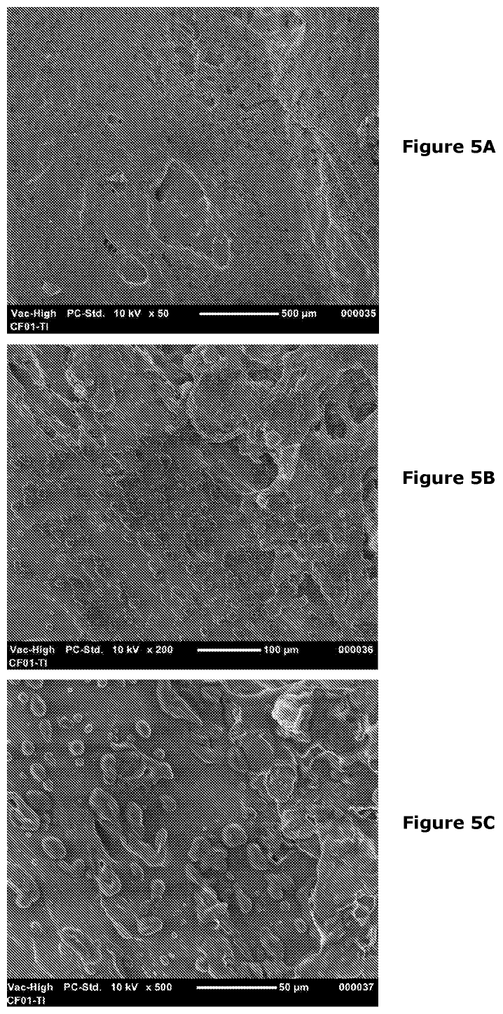

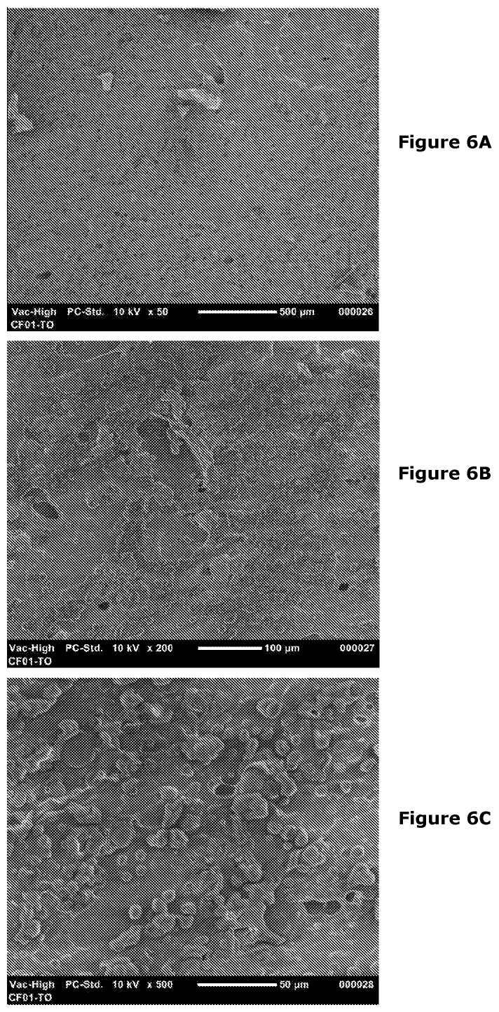

FIG. 5A to 5C show scanning electron microscopy at low (50× magnification)(FIG. 5A), mid (200× magnification)(FIG. 5B) and high (500× magnification)(FIG. 5C) of the surface of the inside of the Cupffee™ Cup. FIG. 4A shows that the surface is not smooth and includes holes or poles. The higher magnification shown demonstrate the lumps on the surface and the surface roughness. The figures show that the surface of the inside and outside of the Cupffee™ cup looks reasonably similar and from FIG. 4C appears to have gelatinised starch granules present in a matrix/film.

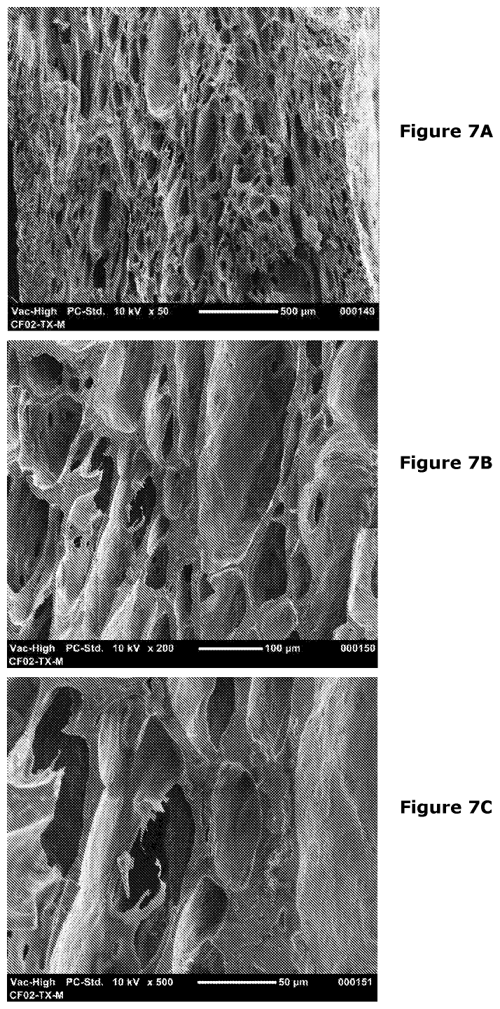

FIGS. 6A to 6C shows scanning electron microscopy at low (50× magnification)(FIG. 6A), mid (200× magnification)(FIG. 6B) and high (500× magnification)(FIG. 6C) of the outside of the inside of the Cupffee™ Cup. The outside surface looks similar to the inside surface shown in FIGS. 4A-4C above. For example a coherent surface with occasional visible pores in the 10 to 100 μm range.

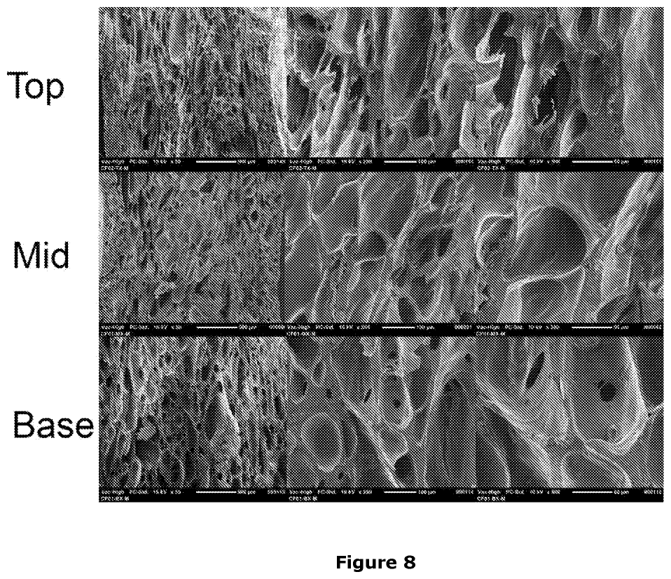

FIGS. 7A to 7C shows scanning electron microscopy at low (50× magnification)(FIG. 7A), mid (200× magnification)(FIG. 7B) and high (500× magnification)(FIG. 7C) of the cross-section of the Cupffee™ cup. This shows large pores, in an elliptical shape. There are some surface differences, the middle of the cross-section having larger pores (likely interconnected) with thin walls.

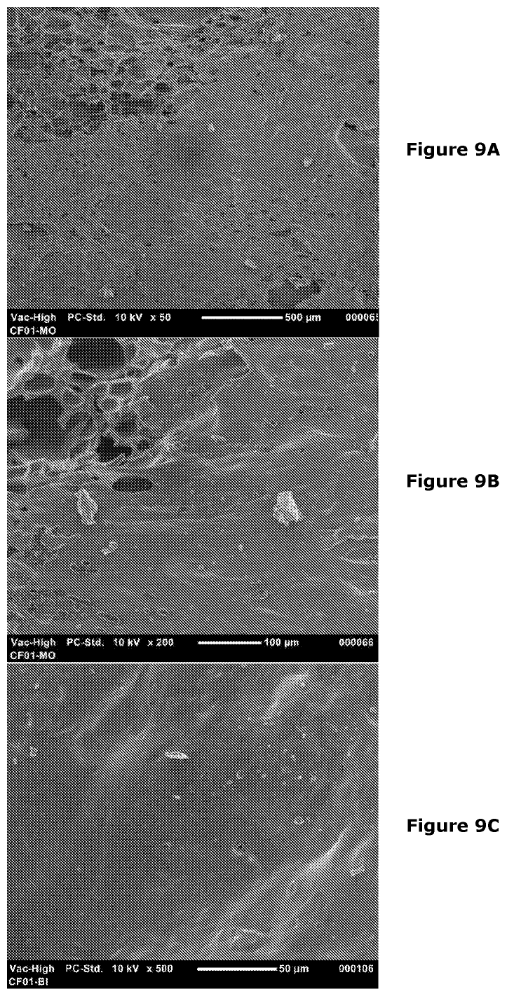

FIG. 8 shows the cross-section of the Cupffee™ cup across the top mid and base sections of the cups showing reasonable similarity across the three regions of the cup.

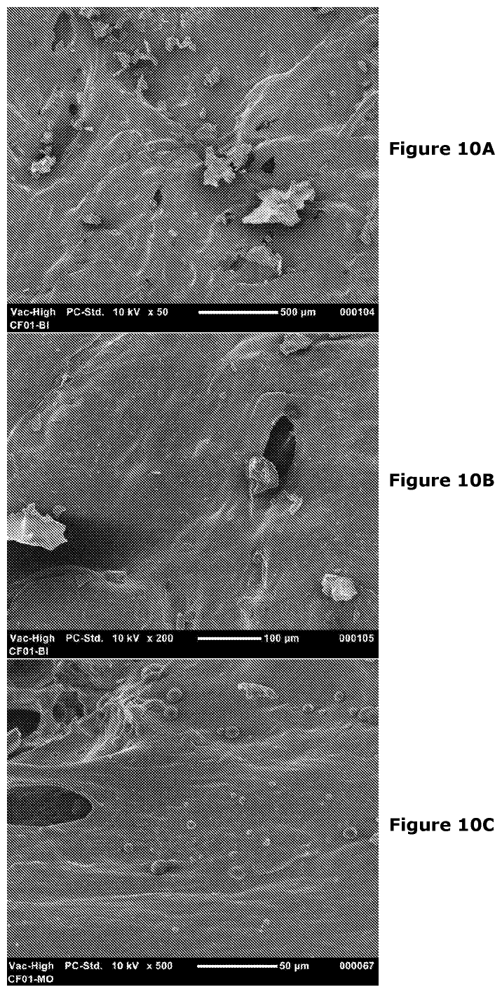

FIGS. 9A to 9C shows scanning electron microscopy at low (50× magnification)(FIG. 9A), mid (200× magnification)(FIG. 9B) and high (500× magnification)(FIG. 9C) of the inside surface of the Cupffee™ cup showing locations where the surface is breached (top left region).

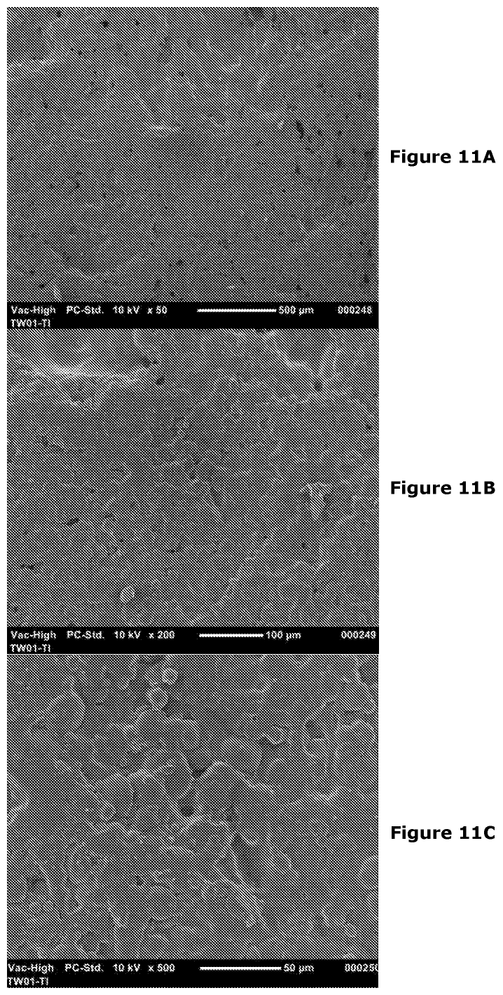

FIGS. 10A to 10C shows scanning electron microscopy at low (50× magnification)(FIG. 10A), mid (200× magnification)(FIG. 10B) and high (500× magnification)(FIG. 10C) of the surface of the base of the Cupffee™ cup showing pores in the base of the samples.

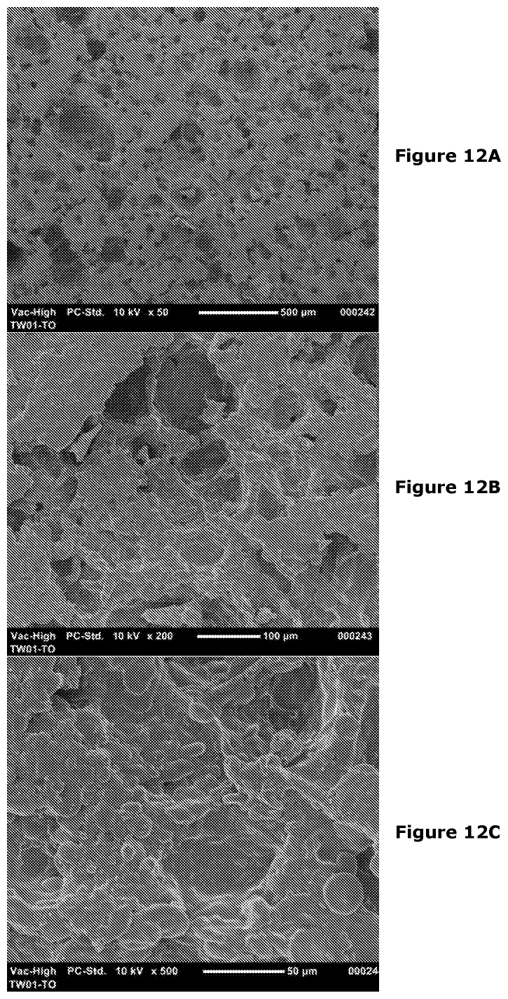

FIGS. 11A to 11C shows scanning electron microscopy at low (50× magnification)(FIG. 11A), mid (200× magnification)(FIG. 11B) and high (500× magnification)(FIG. 11C) of the inside surface of the base of the Twiice® cups.

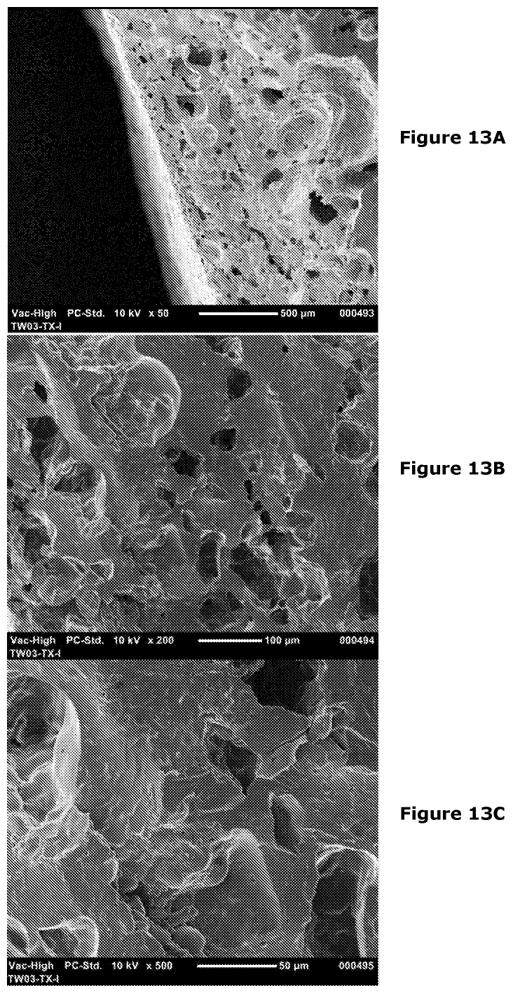

FIGS. 12A to 12C shows scanning electron microscopy at low (50× magnification)(FIG. 12A), mid (200× magnification)(FIG. 12B) and high (500× magnification)(FIG. 12C) of the outside surface of the base of the Twiice® cups. The Twiice® cups show a macro- and microscopically rough surface and shows starch granule glued together in a rough film. The roughness present with shallow pores that appear sealed. The outside surface demonstrates larger pores compared to the inner surface.

Without wishing to be bound by theory, the surface pores of the Twiice® cups may be as a result of how the steam escapes during manufacture.

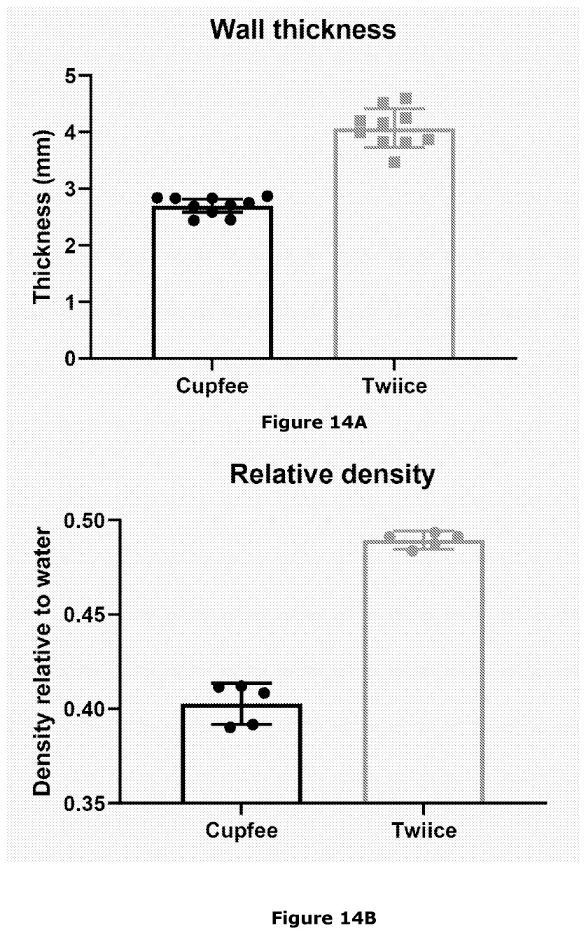

FIGS. 13A to 13C shows scanning electron microscopy at low (50× magnification)(FIG. 13A), mid (200× magnification)(FIG. 13B) and high (500× magnification)(FIG. 13C) of the cross section of the Twiice® cups. The pores are generally smaller and the porosity (amount of pores relative to volume of the sample) are much less than the Cupffee™ cups. The pores have much thicker walls indicating a denser material. There are gelatinised starch granules present in the pores in the cross section of the walls.

In summary, the inside and outside surfaces of the Twiice® cups and Cupffee™ are different with a more rougher surface in the Twiice® cups compared to the Cupffee™ cups. The pores are generally smaller and the porosity is much less with the Twiice® cups compared to the Cupffee cups. The Cupffee cups are defined by holes with some material between the holes, as opposed to material with holes in them with the Twiice® cups.

The pores of the Twiice cups are sealed off at the surface whereas the pores extend to the surface with the Cupffee™ cups. Also the Cupffee™ cup pores are large and interconnected compared to the Twiice® cups which are small and not interconnected. The sealed off pores may be due to bulk density. The Twiice® cups also demonstrated a swelling effect with the starch granules. Without wishing to be bound by theory the starch polymers may be hydrate and thereby swell, which may then contribute to the decrease in water permeability exhibited by the Twiice® cups.

We also tested the ability of the two cups to hold boiling water. The Cupffee™ cup did not hold the water whereas the Twiice® cups did.

FIGS. 15A and 15B compare the wall thickness and relative density of the two cups. The wall thickness was measured with a micrometer and shows that the Twiice® cups have thicker walls. The density was measured using a hydrostatic gravimetric method and shows that the Twiice® cups have a higher density.

### 1.2 Formulations

The following three formulations were tested.
Formulation 1: “Standard” formulation
Formulation 2: Egg yolk powder formulation
Formulation 3: Cornstarch formulation

TABLE 3
Flour based formulations

| | Formulation | | |
|---|---|---|---|
| Manufacturing | 1 | 2 | 3 |
| Ram temperature | 180 | 190 | 190 |
| Press time | 2 | 2 | 2 |

Ingredient (% w/w)

| | | | |
|---|---|---|---|
| Champion Flour | 55.56 | | 54.39 |
| Champion halo flour | | 52.89 | |
| Cornstarch | | | 0.51 |
| Egg pulp | 21.58 | | |
| Egg yolk powder (30% solids) | | 2.64 | |
| Sugar | 22.13 | 21.86 | 22.48 |
| Vanilla flavour | 0.74 | 0.42 | 0.58 |
| Water | | 20.80 | 21.03 |
| Rice bran oil | | 1.38 | 1.02 |

Performance

| | | | |
|---|---|---|---|
| Two hour hold? | Y | Y | Y |
| # cups with splits | 0 | 0 | 0 |

Champion halo flour is a white, low protein soft flour.

Where rice bran oil was added, this was added to coat the particles of flour to make it less sticky to enable easier forming. Without wishing to be bound by theory, the oil may act as a barrier to prevent stickiness.

Formulation 1 was formed into a cup by moulding at 180° C. for 2 second press time and then cooking at 180° C. in an oven. A sample of each cup was tested in triplicate for moisture content, protein content and water activity (aw) as shown below in Table 4.

The moisture content was measured using gravimetry applying a vacuum at 70° C. for 16 hours c/w. The protein content was measured using the Kjeldahl method (titrimetry). The water activity was measured at 20° C.

TABLE 4
Parameter testing of Formulation 1

| | Formulation 1 | | |
|---|---|---|---|
| Parameter | Sample 1 | Sample 2 | Sample 3 |
| Moisture content (g/100 g) | 4.61 | 4.21 | 4.50 |
| Protein content (g/100 g) | 12.0 | 12.1 | 12.0 |
| Water activity (aw) | 0.460 | 0.370 | 0.373 |

TABLE 5
Nutritional information

| | Average quantity per 100 g | | |
|---|---|---|---|
| | Formulation 1 | Formulation 2 | Formulation 3 |
| Energy (kCal) | 391 | 396 | 383 |
| Protein (g) | 12 | 7.6 | 6.6 |
| Fat, total (g) | 3.6 | 4.9 | 2.4 |
| Saturated (g) | 1.0 | 1.1 | 0.4 |
| Carbohydrate (g) | 77.0 | 79.3 | 82.5 |
| sugars (g) | 28.4 | 29.5 | 30.5 |
| Dietary fibre (g) | 1.7 | 2.3 | 2.3 |
| Sodium (mg) | 30 | 15 | 3 |

A range of additional formulations/methodologies were tested as described below. Each of these formulations comprised 22% w/w sugar, 22% w/w egg pulp and 55.6% w/w Champion Medal flour. About 0.5% w/w of a flavouring agent was also included, such as vanilla. The sugar and egg and flavouring agent was first combined and then mixed until the sugar is almost dissolved. Flour is then added and the combined mixture then mixed in a food mixture (Hobart® commercial food mixer). Often this required the mixer to be stopped, the sides of the mixer to be scraped to ensure and flour is pushed into the middle of the mixer. The mixing was stopped when two walls of dough were formed. Using a Hobart® industrial food mixer we found that the mixing tie was generally around 4 minutes (including scraping). The dough was used to form the cups which were formed in the mould and then baked at 180° C. for about 11 minutes. The cups were then subjected to the leak test (boiling water poured into the cup and examined for no leak for at least 24 hrs).

TABLE 6
Formulations of Methods 1 to 7.

| | Mthd 1 | Mthd 2 | Mthd 3 | Mthd 4 | Mthd 5 | Mthd 6 | Mthd 7 |
|---|---|---|---|---|---|---|---|
| Ingredient | (g) | (g) | (g) | (g) | (g) | (g) | (g) |
| Champion Medal Flour | 750 | 750 | 1697 | 1731 | 1681 | 1731 | 1681 |
| Cornstarch | | | | 150 | | 78 | |
| Egg pulp | 291.8 | 291.8 | | | | | |
| Whole egg powder (30% | | | | | 194.2 | | 194.2 |
| solids) | | | | | | | |
| Egg white powder (15% | | | 97.1 | | | | |
| solids) | | | | | | | |
| Water | | | 550.2 | 462.6 | 453.1 | 462.6 | 500 |
| Sugar | 306.7 | 306.7 | 649 | 649 | 663.9 | 649 | 663.9 |
| Flavouring agent | 1.5 | 1.5 | 7.5 | 7.5 | 7.5 | 7.5 | 7.5 |

Method 1: This method used egg pulp and vanilla flavouring (from Sensient Technologies) as the flavouring agent. A total mix size of 1.350 kg was used. The method used cold egg pulp to produce a dough at 15.3° C. The dough was divided into aliquots of about 72-75 g per aliquot. Each piece was simply weighed and added to the press by dropping into the cup (without any shaping of the dough). The ram was engaged into the cup and pressed for 8 to 15 seconds to produce the formed semi baked cup. The mould cup with the dough cup formed about it was then removed for baking. The baked cups passed the leak test.
Method 2: This method used egg pulp and vanilla flavouring (from Sensient Technologies) as the flavouring agent. A total mix size of 1.350 kg was used. The method used cold egg pulp to produce a dough at 17.2° C. The dough was divided into aliquots of about 72-75 g per aliquot. Each piece was simply weighed and added to the press by dropping into the cup (without any shaping of the dough). The ram was engaged into the cup and pressed for 8 to 15 seconds to produce the formed semi baked cup. The mould cup with the dough cup formed about it was then removed for baking. The baked cups passed the leak test.
Method 3: This method used egg pulp and vanilla flavouring (from Sensient Technologies) as the flavouring agent. The flour, sugar, egg white powder and flavouring agent were premixed. Room temperature water was added. A total mix size of 3.279 kg was used. The dough was very sticky. The ram was engaged into the cup and pressed for 8 to 15 seconds to produce the formed semi baked cup. The mould cup with the dough cup formed about it was then removed for baking. The baked cups did not pass the leak test.
Method 4: This method used 5% w/w cornstarch and vanilla flavouring (from Sensient Technologies) as the flavouring agent. A total mix size of 1.552 kg was used. Water at ambient temperature was used to dissolve the sugar more quickly. The dough was prepared at 23.4° C. The dough was divided into aliquots of about 72-75 g per aliquot. Each piece was simply weighed and added to the press by dropping into the cup (without any shaping of the dough). The ram was engaged into the cup and pressed for 8 to 15 seconds to produce the formed semi baked cup. The mould cup with the dough cup formed about it was then removed for baking. The baked cups were found to be hard and passed the leak test.
Method 5: This method used egg yolk powder and vanilla flavouring (from Sensient Technologies) as the flavouring agent. A total mix size of 1.552 kg was used. Water at ambient temperature was used to dissolve the sugar more quickly. The dough was prepared at 23.4° C. The dough was divided into aliquots of about 72-75 g per aliquot. Each piece was simply weighed and added to the press by dropping into the cup (without any shaping of the dough). The ram was engaged into the cup and pressed for 8 to 15 seconds to produce the formed semi baked cup. The mould cup with the dough cup formed about it was then removed for baking. The baked cups passed the leak test.
Method 6: This method used 2.6% w/w cornstarch and vanilla flavouring (from Sensient Technologies) as the flavouring agent. A total mix size of 1.563 kg was used. Water at ambient temperature was used to dissolve the sugar more quickly. The cornstarch was not dissolved in the liquid mix to stop it from swelling. The dough was prepared at 23.4° C. The dough was divided into aliquots of about 72-75 g per aliquot. Each piece was simply weighed and added to the press by dropping into the cup (without any shaping of the dough). The ram was engaged into the cup and pressed for 8 to 15 seconds to produce the formed semi baked cup. The mould cup with the dough cup formed about it was then removed for baking. The baked cups were found to be hard and passed the leak test.
Method 7: This method used egg yolk powder and vanilla flavouring (from Sensient Technologies) as the flavouring agent. A total mix size of 1.564 kg was used. The egg yolk was not dissolved in the liquid mix. The dough was prepared at 21.6° C. The dough was divided into aliquots of about 72-75 g per aliquot. Each piece was simply weighed and added to the press by dropping into the cup (without any shaping of the dough). The ram was engaged into the cup and pressed for 8 to 15 seconds to produce the formed semi baked cup. The mould cup with the dough cup formed about it was then removed for baking. The baked cups passed the leak test.

The following formulations were tested using alternate sources of flour. Each of the recipes was made with a 300 g mixture of egg and sugar at a 50:50 ratio and 7 g of flavouring agent (vanilla).

TABLE 7
Alternate flour based formulations

| | 4 | 5 | 6 | 7 | 8 | 9 |
|---|---|---|---|---|---|---|
| Manufacturing | | | | | | |
| Ram temperature | 180 | 190 | 190 | 190 | 190 | 190 |
| Press time | 2 | 2 | 2 | 7 | 7 | 2 |
| Cups made | 8 | 8 | 8 | 8 | 8 | 8 |
| Ingredient (g) | | | | | | |
| Brown rice | 250 | | | | | |
| Coconut flour | 200 | | | 50 | | |
| Buckwheat flour | | 350 | | | | |
| Gluten free flour | | | 344 | | | |
| Cornflour | | | 5 | | | |
| Oat bran | | | | 100 | | |
| Tapioca | | | | 250 | | |
| Cornmeal | | | | | 350 | |
| Chick pea flour | | | | | | 350 |
| Performance | | | | | | |
| Two hour hold? | yes | yes | no | no | Yes | — |
| # cups with splits | 2 | 1 | 0 | 8 | 3 | — |

The following gluten free formulations were tested.

TABLE 8
Gluten free formulations

| | 10 | 11 | 12 | 13 | 14 | 15 | 16 |
|---|---|---|---|---|---|---|---|
| Manufacturing | | | | | | | |
| Ram temperature | 180 | 180 | 180 | 180 | 180 | 180 | 180 |
| Press time | 2 | 2 | 2 | 2 | 2 | 2 | 2 |
| Ingredient (g) | | | | | | | |
| Bakels gluten free | 250 | 400 | 340 | 340 | | 340 | 340 |
| flour | | | | | | | |
| Egg pulp | 195 | 260 | 260 | 265 | 240 | 240 | 260 |
| Sugar | 200 | 200 | 200 | 200 | | 200 | 200 |
| Flavouring agent | 15 | 15 | 15 | 15 | 15 | 20 | 15 |
| Psyllium husk | 250 | 100 | 100 | 20 | 20 | | 60 |
| Coconut flour | | | | 170 | | | 40 |
| White rice flour | | | | 170 | 185 | | |
| Brown rice flour | | | | | 155 | 100 | |
| Water | | | | 125 | 50 | | |
| Glucose syrup | | | | | 150 | | |
| Ground flax seed | | | | | | 20 | |

In relation to formulation 10 the psyllium husk is mixed with the egg to wet it. The flour was gradually added after 3.5 min. However the mix was too crumbly and so another 98 g of egg was added. The dough was not suitable for making a cup.

In relation to formulation 11 the psyllium was mixed with the egg. The flour was added gradually but the dough was too dry. Therefore, 80 g less flour was used. Approximately 77-80 g of dough was used to form the cup in the mould. The moulded cup was baked for 7 min.

In relation to formulation 12 the psyllium was mixed with the egg. The flour was added gradually. Approximately 78 g of dough was used for each cup in the mould. The moulded cups were baked for 16 min to 20 min. The cups looked good.

In relation to formulation 13 the psyllium was mixed with the egg and set aside for 45 min. The flours were combined and water added. The cups were baked for 7 min and some baked for an additional 16 min. The cups remained soft when cooled.

In relation to formulation 14 the above method was used. The dough pressed well in the dough and the baked cups held boiling water for greater than 24 hrs.

In relation to formulation 15 the above method was used. The dough pressed well in the dough and the baked cups held boiling water for greater than 24 hrs.

In relation to formulation 16 the psyllium husk was mixed with egg and set aside. The flours were combined and then mixed with the egg. Approximately 75-80 g of dough was used in the mould and the pressed cup was baked.

The following vegan formulations were tested.

TABLE 9
Vegan formulations

| Manufacturing | 17 | 18 |
|---|---|---|
| Ram temperature | 180 | 190 |
| Press time | 2 | 2 |

Ingredient (g)

| | | |
|---|---|---|
| Flour | 375 | 1,100 |
| Sugar | 300 | 600 |
| Aquafaba | 200 | |
| Flavouring agent | 10 | 40 |
| Chia mix | | 580 |

In relation to formulation 17 the aquafaba, sugar, flavouring agent (vanilla) was mixed and the flour added. Approximately 70 g aliquots of dough was used for each cup in the mould. The dough was pressed and the pressed cups were baked for 14 min. The baked cups passed the water held test (boiling water for 24 hrs).

The chia, vanilla and sugar was mixed and then the flour added. Approximately 75 g aliquots of dough was used for each cup in the mould. The dough was pressed and the pressed cups were baked at 180° C. for 12 min. The baked cups passed the water held test (boiling water for 24 hrs).

The following example used 2.480 g aquafaba and 750 g flour which were used to form the dough to make the batch of cups. The formulation performed well in the press when subjected to heat and pressure. The cups were then baked in an oven. The nutritional information for these cups is shown in Table 10 below.

TABLE 10
Vegan formulation
NUTRITION INFORMATION
Servings per package: 10
Serving size: 1 Edible cup (Approx. 60 g)

| | Average Quantity | | |
|---|---|---|---|
| | per serving | Average Quantity per 100 g | |
| Energy | 850 kJ | 1410 kJ | |
| | (203 Cal) | (338 Cal) | |
| Protein | 5.9 g | 9.8 | g |
| Fat, total | 1.0 g | 1.6 | g |
| saturated | Less than 1 g | Less than 1 g | |
| Carbohydrate | 41.9 g | 69.9 | g |
| sugars | Less than 1 g | Less than 1 g | |
| Dietary fibre | 1.8 g | 3 | g |
| Sodium | Less than 5 mg | 10 | mg |

When subjected to the hot water test the cups lasted approximately 4 hours.

The following example used 745 g flour, 7 g cornstarch, 290 g water, 310 g sugar, 8 g flavouring, 14 g rape seed oil and 10 g of chia to form the dough to make the batch of cups. The nutritional information for these cups is shown in Table 11 below.

TABLE 11
NUTRITION INFORMATION
Servings per package: 10
Serving size: 1 Edible cup (Approx, 60 g)

| | Average Quantity | |
|---|---|---|
| | per serving | Average Quantity per 100 g |
| Energy | 870 kJ | 1440 kJ |
| | (207 Cal) | (345 Cal) |
| Protein | 3.6 g | 5.9 g |
| Fat, total | 1.4 g | 2.4 g |
| saturated | Less than 1 g | Less than 1 g |
| Carbohydrate | 44.3 g | 73.8 g |
| sugars | 16.3 g | 27.1 g |
| Dietary fibre | 1.4 g | 2.4 g |
| Sodium | Less than 5 mg | Less than 5 mg |

When subjected to the hot water test the cups lasted up to 7 hours.

The following example used 750 g flour, 7 g cornflour, 290 g water, 310 g sugar, 8 g flavouring, 14 coconut oil, 3 tbsp chia seed water mix (1 tbsp chia+3 tbsp water) to make the batch of cups. Once formed via the press with heat and pressure, the cups were baked for 10 mins. The nutritional information for these cups is shown in Table 12 below.

TABLE 12
NUTRITION INFORMATION
Servings per package: 10
Serving size: 1 Edible cup (Approx. 60 g)

| | |
|---|---|
| Average Quantity | |
| per serving | Average Quantity per 100 g |

| | | |
|---|---|---|
| Energy | 870 kJ | 1440 kJ |
| | (207 Cal) | (345 Cal) |

| | | | | |
|---|---|---|---|---|
| Protein | 3.6 | g | 6 | g |
| Fat, total | 1.5 | g | 2.4 | g |

| | | | |
|---|---|---|---|
| saturated | Less than 1 g | 1.3 | g |

| | | | | |
|---|---|---|---|---|
| Carbohydrate | 44.2 | g | 73.7 | g |
| sugars | 16.2 | g | 27 | g |
| Dietary fibre | 1.5 | g | 2.4 | g |

| | | |
|---|---|---|
| Sodium | Less than 5 mg | Less than 5 mg |

When subjected to the hot water test (100° C.) the cups held their integrity for 1.5 days.

The following example used 750 g flour, 7 g cornflower, 290 g water, 310 sugar, 8 g flavouring, 14 g rice bran oil, 1 tbsp chia mix (1 tbsp chia+3 tbsp water) to make the batch of cups. Once formed via the press with heat and pressure, the cups were baked for 10 mins. The nutritional information for these cups is shown in Table 11 below.

TABLE 13
NUTRITION INFORMATION
Servings per package: 10
Serving size: 1 Edible cup (Approx. 60 g)

| | Average Quantity | | |
|---|---|---|---|
| | per serving | Average Quantity per 100 g | |
| Energy | 870 kJ | 1440 kJ | |
| | (207 Cal) | (345 Cal) | |
| Protein | 3.6 g | 6 | g |
| Fat, total | 1.5 g | 2.4 | g |
| saturated | Less than 1 g | Less than 1 g | |
| Carbohydrate | 44.2 g | 73.7 | g |
| sugars | 16.2 g | 27 | g |
| Dietary fibre | 1.5 g | 2.4 | g |

| | | |
|---|---|---|
| Sodium | Less than 5 mg | Less than 5 mg |

This sample was not subjected to the hot water test.

The following example used 1400 g water, 1240 g sugar, 5 g cornstarch, 12 g flavour, 40 g chocolate flavour, 248 g coco powder to make the batch of cups. The nutritional information for these cups is shown in Table 14 below.

TABLE 14
NUTRITION INFORMATION
Servings per package: 10
Serving size: 1 Edible cup (Approx. 58 g)

| | Average Quantity | |
|---|---|---|
| | per serving | Average Quantity per 100 g |
| Energy | 810 kJ | 1390 kJ |
| | (193 Cal) | (333 Cal) |
| Protein | 3.9 g | 6.7 g |
| Fat, total | Less than 1 g | 1.4 g |
| saturated | Less than 1 g | Less than 1 g |
| Carbohydrate | 41.8 g | 72.1 g |
| sugars | 15.2 g | 26.1 g |
| Dietary fibre | 2.1 g | 3.7 g |
| Sodium | Less than 5 mg | Less than 5 mg |

This sample was not subjected to the hot water test.

The following example used 750 g flour, 2 g cornstarch, 290 g water, 310 g sugar, 8 g flavouring, 14 g rice bran oil to make the batch of cups. The dough was subjected to three presses of 10 seconds each at a temperature of 190° C. Once formed via the press with heat and pressure, the cups were baked for 10 mins. The nutritional information for these cups is shown in Table 15 below.

TABLE 15
NUTRITION INFORMATION
Servings per package: 10
Serving size: 1 Edible cup (Approx. 60 g)

| | Average Quantity | |
|---|---|---|
| | per serving | Average Quantity per 100 g |
| Energy | 870 kJ | 1440 kJ |
| | (207 Cal) | (345 Cal) |
| Protein | 3.5 g | 5.9 g |
| Fat, total | 1.3 g | 2.1 g |
| saturated | Less than 1 g | Less than 1 g |
| Carbohydrate | 44.6 g | 74.4 g |
| sugars | 16.4 g | 27.4 g |
| Dietary fibre | 1.3 g | 2.1 g |
| Sodium | Less than 5 mg | Less than 5 mg |

This sample was not subjected to the hot water test.

The following example used 750 g flour, 290 carbonated water, 310 sugar, 1 tsp xanthan gum, 8 g flavouring, 14 rice bran oil to make the batch of cups. The sugar was mixed with the xanthan gum together and then water was added. The flavoring was then added along with the oil and finally the flour. The dough was subjected to three presses of 10 seconds each at a temperature of 190° C. Once formed via the press with heat and pressure, the cups were baked for 10 mins. The nutritional information for these cups is shown in Table 16 below.

TABLE 16
NUTRITION INFORMATION
Servings per package: 10
Serving size: 1 Edible cup (Approx. 60 g)

| | Average Quantity | |
|---|---|---|
| | per serving | Average Quantity per 100 g |
| Energy | 870 kJ | 1440 kJ |
| | (207 Cal) | (345 Cal) |
| Protein | 3.5 g | 5.9 g |
| Fat, total | 1.3 g | 2.1 g |
| saturated | Less than 1 g | Less than 1 g |
| Carbohydrate | 44.6 g | 74.4 g |
| sugars | 16.4 g | 27.4 g |
| Dietary fibre | 1.3 g | 2.1 g |
| Sodium | Less than 5 mg | Less than 5 mg |

This sample was not subjected to the hot water test.

The following example used 280 g sugar, 270 g water, 50 g ‘Nuttelex’ vegan butter, 8 g flavouring, and 750 g flour to make the batch of cups. The dough was subjected to heat and pressure in the press and then baked in an oven. The cups had a slight “crunch” to them when eaten. The nutritional information for these cups is shown in Table 17 below.

TABLE 17
NUTRITION INFORMATION
Servings per package: 10
Serving size: 1 Edible cup (Approx. 58 g)

| | |
|---|---|
| Average Quantity | Average Quantity |
| per serving | per 100 g |

| | | |
|---|---|---|
| Energy | 850 kJ | 1460 kJ |
| | (203 Cal) | (349 Cal) |

| | | | | |
|---|---|---|---|---|
| Protein | 3.4 | g | 5.9 | g |
| Fat, total | 2.2 | g | 3.8 | g |

| | | |
|---|---|---|
| saturated | Less than 1 g | Less than 1 g |

| | | | | |
|---|---|---|---|---|
| Carbohydrate | 41.7 | g | 71.9 | g |
| sugars | 14.4 | g | 24.9 | g |
| Dietary fibre | 1.2 | g | 2.1 | g |
| Sodium | 10 | mg | 20 | mg |

The cups were subjected to a hot water test (100° C.) and retained their integrity for almost 24 hours. That is, by 24 hrs the cups leaked and split.

The following example used 280 g sugar, 270 g water, 50 g almond butter, 8 g flavouring, 750 g and flour to make the batch of cups. The cups performed well in the press after being subjected to heat and pressure. The cups were then then baked in an oven. The nutritional information for these cups is shown in Table 18 below.

TABLE 18
NUTRITION INFORMATION
Servings per package: 10
Serving size: 1 Edible cup (Approx. 61 g)

| | |
|---|---|
| Average Quantity | Average Quantity |
| per serving | per 100 g |

| | | |
|---|---|---|
| Energy | 890 kJ | 1470 kJ |
| | (214 Cal) | (350 Cal) |

| | | | | |
|---|---|---|---|---|
| Protein | 4.2 | g | 6.8 | g |
| Fat, total | 2 | g | 3.2 | g |

| | | |
|---|---|---|
| saturated | Less than 1 g | Less than 1 g |

| | | | | |
|---|---|---|---|---|
| Carbohydrate | 44.2 | g | 72.4 | g |
| sugars | 15.3 | g | 25.1 | g |
| Dietary fibre | 1.3 | g | 2.1 | g |
| Sodium | 5 | mg | 10 | mg |

The cups were subjected to a hot water test (100° C.) and held their integrity for at least 5 hours.

The following example used 280 g water, 50 g almond butter, 8 g flavour, and 700 g flour to make the batch of cups. The dough was subjected to heat and pressure in the press and then baked in an oven. The nutritional information for these cups is shown in Table 19 below.

TABLE 19
NUTRITION INFORMATION
Servings per package: 10
Serving size: 1 Edible cup (Approx. 58 g)

| | |
|---|---|
| Average Quantity | Average Quantity |
| per serving | per 100 g |

| | | |
|---|---|---|
| Energy | 850 kJ | 1470 kJ |
| | (204 Cal) | (351 Cal) |

| | | | | |
|---|---|---|---|---|
| Protein | 3.9 | g | 6.7 | g |
| Fat, total | 1.9 | g | 3.3 | g |

| | | |
|---|---|---|
| saturated | Less than 1 g | Less than 1 g |

| | | | | |
|---|---|---|---|---|
| Carbohydrate | 42 | g | 72.5 | g |
| sugars | 15.2 | g | 26.2 | g |
| Dietary fibre | 1.2 | g | 2.1 | g |
| Sodium | 5 | mg | 10 | mg |

The cups were subjected to a hot water test (100° C.). The cups held their structure for over 27 hours and there were no leaks for at least 7 hours.

The following example used 170 g water, 100 g ‘Nuttelex’, 8 g flavouring, 750 g flour to make the batch of cups. The process included creaming the butter and sugar for about 20 minutes. Then water was added and flavouring, and then the flour. The dough was subjected to heat and pressure in the press and then baked in an oven. This gave an even bake, more biscuity, and a good taste. The nutritional information for these cups is shown in Table 20 below.

TABLE 20
NUTRITION INFORMATION
Servings per package: 10
Serving size: 1 Edible cup (Approx. 61 g)

| | |
|---|---|
| Average Quantity | Average Quantity |
| per serving | per 100 g |

| | | |
|---|---|---|
| Energy | 920 kJ | 1500 kJ |
| | (219 Cal) | (359 Cal) |

| | | | | |
|---|---|---|---|---|
| Protein | 3.5 | g | 5.7 | g |
| Fat, total | 3.9 | g | 6.3 | g |

| | | | |
|---|---|---|---|
| saturated | Less than 1 g | 1.5 | g |

| | | | | |
|---|---|---|---|---|
| Carbohydrate | 42 | g | 68.9 | g |
| sugars | 14.5 | g | 23.8 | g |
| Dietary fibre | 1.2 | g | 2 | g |
| Sodium | 20 | mg | 30 | mg |

The cups were not subjected to a hot water test.

The following example used 170 g water, 280 g glucose, 100 g coconut oil, 8 g flavour and 750 g flour to make the batch of cups. The dough was subjected to heat and pressure in the press and then baked in an oven. The cups were not sweet and had a biscuity texture. The nutritional information for these cups is shown in Table 21 below.

TABLE 21
NUTRITION INFORMATION
Servings per package: 10
Serving size: 1 Edible cup (Approx. 50 g)

| | |
|---|---|
| Average Quantity | Average Quantity |
| per serving | per 100 g |

| | | |
|---|---|---|
| Energy | 800 kJ | 1600 kJ |
| | (191 Cal) | (381 Cal) |

| | | | | |
|---|---|---|---|---|
| Protein | 3 | g | 5.9 | g |
| Fat, total | 4.8 | g | 9.7 | g |
| saturated | 4 | g | 8.1 | g |
| Carbohydrate | 33.4 | g | 66.9 | g |
| sugars | 3.3 | g | 6.7 | g |
| Dietary fibre | 1 | g | 2.1 | g |
| Sodium | 10 | mg | 25 | mg |

The cups were not subjected to a hot water test.

The following example used 170 g water, 250 g glucose, 100 g coconut oil, 8 g flavouring, and 750 g flour to make the batch of cups. The dough was subjected to heat and pressure in the press and then baked in an oven. The cups performed well in the press. The nutritional information for these cups is shown in Table 22 below.

TABLE 22
NUTRITION INFORMATION
Servings per package: 10
Serving size: 1 Edible cup (Approx. 56 g)

| | |
|---|---|
| Average Quantity | Average Quantity |
| per serving | per 100 g |

| | | |
|---|---|---|
| Energy | 900 kJ | 1600 kJ |
| | (214 Cal) | (382 Cal) |

| | | | | |
|---|---|---|---|---|
| Protein | 3.4 | g | 6.1 | g |
| Fat, total | 5.6 | g | 9.9 | g |
| saturated | 4.6 | g | 8.3 | g |
| Carbohydrate | 37.2 | g | 66.4 | g |
| sugars | 3.5 | g | 6.2 | g |
| Dietary fibre | 1.2 | g | 2.2 | g |
| Sodium | 10 | mg | 20 | mg |

The cups were subjected to a hot water test (100° C.). The cups leaked by 24 hrs.

The following example used 170 g water, 250 g sugar, 100 g coconut oil, 12 g flavour and 750 g flour to make the batch of cups. The dough was subjected to heat and pressure in the press and then baked in an oven. The cups performed well in the press. The nutritional information for these cups is shown in Table 23 below.

TABLE 23
NUTRITION INFORMATION
Servings per package: 10
Serving size: 1 Edible cup (Approx. 60 g)

| | |
|---|---|
| Average Quantity | Average Quantity |
| per serving | per 100 g |

| | | |
|---|---|---|
| Energy | 960 kJ | 1590 kJ |
| | (228 Cal) | (380 Cal) |

| | | | | |
|---|---|---|---|---|
| Protein | 3.5 | g | 5.8 | g |
| Fat, total | 5.6 | g | 9.4 | g |
| saturated | 4.7 | g | 7.9 | g |
| Carbohydrate | 40.4 | g | 67.3 | g |
| sugars | 13 | g | 21.6 | g |
| Dietary fibre | 1.2 | g | 2 | g |

| | | |
|---|---|---|
| Sodium | Less than 5 mg | Less than 5 mg |

The cups were subjected to a hot water test (100° C.). After 6 hours the cup wall was soft and belling, but still containing water. By 24 hrs there were no splits in the cup but leaking through general permeation. Still containing water. By 27 hours the cup leaked via a split.

The following example used 180 g water, 250 g sugar, 75 g coconut oil, 730 g flour and 12 g flavouring to make the batch of cups. The dough was subjected to heat and pressure in the press and then baked in an oven. The cups performed well in the press. The nutritional information for these cups is shown in Table 24 below.

TABLE 24
NUTRITION INFORMATION
Servings per package: 10
Serving size: 1 Edible cup (Approx. 59 g)

| | |
|---|---|
| Average Quantity | Average Quantity |
| per serving | per 100 g |

| | | |
|---|---|---|
| Energy | 920 kJ | 1550 kJ |
| | (219 Cal) | (371 Cal) |

| | | | | |
|---|---|---|---|---|
| Protein | 3.4 | g | 5.8 | g |
| Fat, total | 4.5 | g | 7.5 | g |
| saturated | 3.6 | g | 6.2 | g |
| Carbohydrate | 40.8 | g | 69.1 | g |
| sugars | 13.3 | g | 22.5 | g |
| Dietary fibre | 1.2 | g | 2.1 | g |

| | | |
|---|---|---|
| Sodium | Less than 5 mg | Less than 5 mg |

The cups were subjected to a hot water test (100° C.). The cups split by 24 hrs and leaked.

The following example used 210 g water, 250 g sugar, 40 g rice bran oil, 12 g flavouring and 700 g flour to make the batch of cups. The sugar was mixed with the water to dissolve the sugar. The oil was added to the sugar along with the flavoring. Then the flour was added. The dough was subjected to heat and pressure in the press and then baked in an oven. The nutritional information for these cups is shown in Table 25 below.

TABLE 25
NUTRITION INFORMATION
Servings per package: 10
Serving size: 1 Edible cup (Approx. 57 g)

| | |
|---|---|
| Average Quantity | Average Quantity |
| per serving | per 100 g |

| | | |
|---|---|---|
| Energy | 850 kJ | 1500 kJ |
| | (204 Cal) | (357 Cal) |

| | | | | |
|---|---|---|---|---|
| Protein | 3.4 | g | 6 | g |
| Fat, total | 2.7 | g | 4.7 | g |

| | | |
|---|---|---|
| saturated | Less than 1 g | Less than 1 g |

| | | | | |
|---|---|---|---|---|
| Carbohydrate | 40.9 | g | 71.7 | g |
| sugars | 13.7 | g | 24 | g |
| Dietary fibre | 1.2 | g | 2.1 | g |

| | | |
|---|---|---|
| Sodium | Less than 5 mg | Less than 5 mg |

The cups were subjected to a hot water test (100° C.). No leaks for at least 7 hours but structure held for over 27 hours.

The following example used 290 g water, 310 g sugar, 7 g cornstarch, 12 g flavouring, 14 g rice bran oil, and 750 g flour to make the batch of cups. The dough was subjected to heat and pressure in the press and then baked in an oven. The nutritional information for these cups is shown in Table 26 below.

TABLE 26
NUTRITION INFORMATION
Servings per package: 10
Serving size: 1 Edible cup (Approx. 58 g)

| | |
|---|---|
| Average Quantity | Average Quantity |
| per serving | per 100 g |

| | | |
|---|---|---|
| Energy | 840 kJ | 1440 kJ |
| | (200 Cal) | (345 Cal) |

| | | | | |
|---|---|---|---|---|
| Protein | 3.4 | g | 5.8 | g |
| Fat, total | 1.2 | g | 2.1 | g |

| | | |
|---|---|---|
| saturated | Less than 1 g | Less than 1 g |

| | | | | |
|---|---|---|---|---|
| Carbohydrate | 43.2 | g | 74.5 | g |
| sugars | 15.8 | g | 27.2 | g |
| Dietary fibre | 1.2 | g | 2.1 | g |

| | | |
|---|---|---|
| Sodium | Less than 5 mg | Less than 5 mg |

The cups were subjected to a hot water test (100° C.). No leaks for at least 7 hours and the structure held for over 27 hours.

The following example used 240 g water, 250 g sugar, 30 g rice bran oil, 12 g flavouring, 700 g flour to make the batch of cups. The dough was subjected to heat and pressure in the press and then baked in an oven. The nutritional information for these cups is shown in Table 27 below.

TABLE 27
NUTRITION INFORMATION
Servings per package: 10
Serving size: 1 Edible cup (Approx. 60 g)

| | |
|---|---|
| Average Quantity | Average Quantity |
| per serving | per 100 g |

| | | |
|---|---|---|
| Energy | 890 kJ | 1480 kJ |
| | (212 Cal) | (353 Cal) |

| | | | | |
|---|---|---|---|---|
| Protein | 3.6 | g | 6 | g |
| Fat, total | 2.3 | g | 3.8 | g |

| | | |
|---|---|---|
| saturated | Less than 1 g | Less than 1 g |

| | | | | |
|---|---|---|---|---|
| Carbohydrate | 43.5 | g | 72.5 | g |
| sugars | 14.5 | g | 24.2 | g |
| Dietary fibre | 1.3 | g | 2.1 | g |

| | | |
|---|---|---|
| Sodium | Less than 5 mg | Less than 5 mg |

The cups were subjected to a hot water test (100° C.). The cups had not leaked after 6 hours, and by 24 hours had leaked.

The following example used 210 g water, 250 g sugar, 40 g rice bran oil, 12 g flavouring and 700 g flour to make the batch of cups. The dough was subjected to heat and pressure in the press and then baked in an oven. The nutritional information for these cups is shown in Table 28 below.

TABLE 28
NUTRITION INFORMATION
Servings per package: 10
Serving size: 1 Edible cup (Approx. 61 g)

| | |
|---|---|
| Average Quantity | Average Quantity |
| per serving | per 100 g |

| | | |
|---|---|---|
| Energy | 910 kJ | 1500 kJ |
| | (218 Cal) | (357 Cal) |

| | | | | |
|---|---|---|---|---|
| Protein | 3.6 | g | 6 | g |
| Fat, total | 2.9 | g | 4.7 | g |

| | | |
|---|---|---|
| saturated | Less than 1 g | Less than 1 g |

| | | | | |
|---|---|---|---|---|
| Carbohydrate | 43.8 | g | 71.7 | g |
| sugars | 14.6 | g | 24 | g |
| Dietary fibre | 1.3 | g | 2.1 | g |

| | | |
|---|---|---|
| Sodium | Less than 5 mg | Less than 5 mg |

The cups were subjected to a hot water test (100° C.). The cups had not leaked after 6 hours, and by 24 hours had leaked

The following example used 210 g water, 250 g sugar, 40 g rice bran oil, 8 g vanilla flavour, 10 g chocolate flavour and 51 g coco powder to make the batch of cups. The dough was subjected to heat and pressure in the press and then baked in an oven. The nutritional information for these cups is shown in Table 29 below.

TABLE 29
NUTRITION INFORMATION
Servings per package: 10
Serving size: 1 Edible cup (Approx. 61 g)

| | |
|---|---|
| Average Quantity | Average Quantity |
| per serving | per 100 g |

| | | |
|---|---|---|
| Energy | 900 kJ | 1470 kJ |
| | (215 Cal) | (352 Cal) |

| | | | | |
|---|---|---|---|---|
| Protein | 3.9 | g | 6.4 | g |
| Fat, total | 3.2 | g | 5.3 | g |

| | | | |
|---|---|---|---|
| saturated | Less than 1 g | 1.2 | g |

| | | | | |
|---|---|---|---|---|
| Carbohydrate | 42 | g | 68.8 | g |
| sugars | 15.1 | g | 24.7 | g |
| Dietary fibre | 2.1 | g | 3.5 | g |

| | | |
|---|---|---|
| Sodium | Less than 5 mg | Less than 5 mg |

The cups were subjected to a hot water test (100° C.). There were No leaks for at least 2 hours.

The following example used 290 g water, 310 g sugar, 14 g rice bran oil, 12 g flavouring, 60 g flaxseed, 50 g tapioca flour and 700 g flour to make the batch of cups. The dough was subjected to heat and pressure in the press and then baked in an oven. The nutritional information for these cups is shown in Table 30 below.

TABLE 30
NUTRITION INFORMATION
Servings per package: 10
Serving size: 1 Edible cup (Approx. 59 g)

| | |
|---|---|
| Average Quantity | Average Quantity |
| per serving | per 100 g |

| | | |
|---|---|---|
| Energy | 860 kJ | 1460 kJ |
| | (206 Cal) | (350 Cal) |

| | | | | |
|---|---|---|---|---|
| Protein | 3.6 | g | 6.2 | g |
| Fat, total | 2.3 | g | 3.9 | g |

| | | |
|---|---|---|
| saturated | Less than 1 g | Less than 1 g |

| | | | | |
|---|---|---|---|---|
| Carbohydrate | 42.1 | g | 71.4 | g |
| sugars | 15.3 | g | 25.9 | g |
| Dietary fibre | 1.9 | g | 3.2 | g |
| Sodium | 5 | mg | 10 | mg |

The cups were subjected to a hot water test (100° C.). No leaks for at least 7 hours but structure held for over 27 hours.

The following example used 290 g water, 310 g sugar, 14 g rice bran, 12 g flavouring, 30 g flaxseed, 50 g tapioca, 700 g flour to make the batch of cups. The dough was subjected to heat and pressure in the press and then baked in an oven. The nutritional information for these cups is shown in Table 30 below.

TABLE 31
NUTRITION INFORMATION
Servings per package: 10
Serving size: 1 Edible cup (Approx. 58 g)

| | |
|---|---|
| Average Quantity | Average Quantity |
| per serving | per 100 g |

| | | |
|---|---|---|
| Energy | 850 kJ | 1460 kJ |
| | (202 Cal) | (348 Cal) |

| | | | | |
|---|---|---|---|---|
| Protein | 3.4 | g | 5.9 | g |
| Fat, total | 1.8 | g | 3 | g |

| | | |
|---|---|---|
| saturated | Less than 1 g | Less than 1 g |

| | | | | |
|---|---|---|---|---|
| Carbohydrate | 42.4 | g | 73.2 | g |
| sugars | 15.4 | g | 26.6 | g |
| Dietary fibre | 1.5 | g | 2.6 | g |

| | | | |
|---|---|---|---|
| Sodium | Less than 5 mg | 5 | mg |

The cups were subjected to a hot water test (100° C.). No leaks for at least 6 hours.

1. A method for providing a biodegradable and/or edible tableware having a three dimensional shape, comprising forming a dough, the dough comprising a mixture of
45% to 65% by weight of a flour,
35% to 55% by weight of a gelling agent and optionally a sugar,
wherein if a sugar is present, the ratio of the gelling agent to the sugar is from 0.8:1 to 1:0.8,
wherein if the gelling agent is a vegetable oil, the gelling agent includes the addition of water to the dough,
placing the dough into a mould, the mould further comprising a female mould and a male ram whose exterior shape mirrors that of the desired internal shape of the biodegradable and/or edible tableware,
subjecting the dough to both heat and pressure to form and partially cook the three dimensional shaped tableware, the heat being provided by the male ram at a temperature of between 150° C. to 220° C., and
placing the three-dimensional shaped tableware in an oven and baking the three-dimensional shaped tableware to produce the biodegradable and/or edible tableware.

2. The method of claim 1, wherein the gelling agent comprises a fat or oil.

3. The method of claim 1, wherein the tableware has:
a) a wall thickness of 3 to 5 mm, or
b) a density of 0.45 to 0.65 relative to water, or
c) a water activity (aw) of less than 0.54, or
d) a moisture content of less than 6.5 g/100 g, or
e) a protein content of 8 to 16 g/100 g, or
f) any combination of (a) to (e).

4. The method of claim 1,
wherein the dough comprises:
a gelling agent, the gelling agent comprising a fat or oil, and
a sugar,
wherein if the flour comprises a gluten free flour, then the dough comprises an additional source of flour, that is not a wheat flour, and a source of fibre, and
wherein the tableware has the capability of retaining a liquid without leaking the liquid for at least 2 hrs.

5. The method of claim 4, wherein the additional source of flour is selected from coconut flour, white rice flour, brown rice flour, chia seeds, flaxseeds, almond, hazelnut, or a combination thereof.

6. The method of claim 1, wherein the dough comprises a sugar.

7. The method of claim 1, wherein the mould is adapted to allow any generated steam to be released from the dough.

8. The method of claim 7, wherein the mould is an open mould.

9. The method of claim 1, wherein the mould exerts at least 800 kg of force.

10. (canceled)

11. The method of claim 1, wherein the gelling agent is selected from egg, an egg substitute, corn starch, aquafaba, vegetable oil, or a combination thereof, and
wherein if a vegetable oil is used, the dough also includes the addition of water.

12. The method of claim 1, wherein the dough comprises about 15 to 30% by weight of the gelling agent.

13.-14. (canceled)

15. The method of claim 4, wherein the dough comprises about 15% to 30% by weight of the sugar.

16.-17. (canceled)

18. The method of claim 1, wherein the dough comprises 0.5% to 7.5% by weight corn starch, and suitable ranges may be selected from between any of these values.

19.-22. (canceled)

23. The method of claim 1, wherein the dough comprises up to 10% by weight of a flavouring agent.

24.-32. (canceled)

33. The method of claim 1, wherein the sugar is present and the gelling agent and the sugar are mixed to form a first mixture.

34. The method of claim 33, wherein the sugar is substantially dissolved in the first mixture.

35. The method of claim 33, wherein a flavouring agent is added to the first mixture.

36. The method of claim 33, wherein the flour is added to the first mixture.

37. The method of claim 1, wherein the dough has a moulding temperature (prior to placing the dough into the mould) that is 12° C. to 23° C.

38. The method of claim 1, wherein the dough is cooked in the mould for about 1 sec to 30 sec to produce a partially cooked biodegradable and/or edible tableware.

39. The method of claim 38, wherein the partially cooked biodegradable and/or edible tableware is removed from the mould and baked at 150° C. to 220° C.

40. The method of claim 39, wherein the partially cooked biodegradable and/or edible tableware is baked for 7 min to 15 min.

41.-43. (canceled)
